(19) United States
(12) Patent Application Publication
(10) Pub. No.: US 2026/0035204 A1
(43) Pub. Date: Feb. 5, 2026

(54) Ovality Resistance of a Spirally Wound Fiber Tube

(71) Applicant: Sonoco Development, Inc., Hartsville, SC (US)

(72) Inventors: Michael David Zold, Hartsville, SC (US); David E. Rhodes, Hartsville, SC (US)

(73) Assignee: Sonoco Development, Inc., Hartsville, SC (US)

(21) Appl. No.: 19/282,420

(22) Filed: Jul. 28, 2025

Related U.S. Application Data
(60) Provisional application No. 63/677,169, filed on Jul. 30, 2024.

(51) Int. Cl. B65H 75/10; B31C 3/00; B31C 11/04

(52) U.S. Cl. CPC B65H 75/10; B31C 3/00; B31C 11/04; B65H 2701/5112

(57) ABSTRACT

A paperboard winding tube of enhanced compression stiffness and resistance to deformations leading to ovality under gravity type loading is disclosed. The paperboard winding tube may include a cylindrical body wall formed from a plurality of structural paperboard layers with at least one central structural paperboard layer disposed between at least one radially inward structural paperboard layer and at least one radially outward structural paperboard layer. The radially inward and the radially outward structural paperboard layers may be formed of a paperboard ply of a first stiffness, and the central structural paperboard layer may be formed of a paperboard ply of a second stiffness that is less than the first stiffness. The arrangement of the plurality of structural paperboard layers increases the compression stiffness of the paperboard winding tube to resist deformations leading to ovality of the cylindrical body wall under gravity type loading of the paperboard winding tube.

### CROSS-REFERENCE TO RELATED APPLICATION

This application claims the benefit of U.S. Provisional Application No. 63/677,169 filed Jul. 30, 2024, which is incorporated by reference herein.

### TECHNICAL FIELD

The present disclosure relates generally to spirally wound fiber cores or tubes for winding yarns, films, paper, metals, non-woven materials, roofing membranes and the like, and, more particularly, to multi-grade paperboard winding fiber cores or tubes having improved resistance to deforming from a round cross-sectional shape to an ovoid cross-sectional shape.

### BACKGROUND

Paperboard cores or tubes are widely used in the paper, film and textile industries to wind material as it is manufactured. As used herein, the terms “core” and “tube” are used interchangeably to refer to the hollow cylindrical structures upon which paper, film, textiles and other material webs are wound. The paperboard tubes themselves are manufactured continuously by spirally winding multiple paperboard strips, or plies, around a stationary mandrel. Although paperboard is relatively weak on a single ply basis, a tube constructed from multiple spirally wound plies of paperboard can attain substantial strength.

In recent years, paperboard winding tubes have been subjected to increasingly higher levels of stress due to changes in film and fiber properties, improvements in winders, and changes in package sizes. In the textile industry, substantial increases have been seen in the strength of various yarns, such as multi-filament continuous yarns of nylon, polyester, etc., resulting in the application of increased compressive force to the tube exterior. In the film industry, improved materials and processes have also resulted in higher winding tensions and increased stress on film winding cores. At the same time, efficiency considerations and improvements in automation have resulted in increased quantities of yarn and film wound onto individual yarn and film packages, further increasing the compressive forces applied to the paperboard winding tubes. In summary, higher tube strength requirements have resulted from increased loads applied to the winding tubes by winding machine enhancements.

Moreover, these increasing compressive forces have increased the occurrences of a stiffness type failure not associated to a tube strength failure. This tube “failure” is commonly called inside diameter (ID) “comedown”, which involves a decrease in the tube ID during the winding process. ID comedown results a uniform radial pressure load applied from wound film or yarn. In many textile and film winding processes, the winding tube is supported on a winding mandrel. In the event of substantial winding core ID comedown during the winding process, the paperboard tube forming the interior of the finished yarn or film package, can so tightly grip the exterior surface of a winding mandrel that the final package cannot be removed from the winding mandrel until the wound yarn or film has been removed from the winding tube, typically by cutting, thus destroying the yarn or film.

It is generally understood that the overall strength of paperboard tubes can be increased by increasing tube wall thickness and/or by employing stronger paper strips for the plies in the winding tube. In this regard, paper is available in a wide variety of strengths. Paper strength is improved by increasing the mechanical refining of paperboard pulps and by compressing the paperboard during manufacture. Further, paperboard strength is influenced by fiber type and quality. As a general rule, stronger paperboard sheets have a higher density than low strength paperboard sheets.

In response to industry needs for stronger paperboard cores, substantial effort has been focused on tube manufacturing processes and tube designs. Paperboard is an orthotropic material. Thus, paperboard strength properties are different in the machine direction (MD) and in the cross machine direction (CD). MD refers to the direction of paper production during the manufacturing process, and CD refers to the direction perpendicular to the MD in the plane of the paper. The difference in properties between the MD and CD can be attributed to the tendency for more paper fibers to be aligned along the MD as compared to the CD. The orthotropic properties of paper influence tube strength and complicate the accurate prediction of tube strength.

In addition, the paperboard strips used to prepare spirally wound paperboard tubes are wound at varying angles, and tube properties depend, at least in part, on the winding angle of the spirally wound strips. The winding angle thus further increases the difficulty of accurately predicting paperboard tube properties.

As with other materials, paperboard tubes exhibit different strength values depending on which strength characteristics are measured. These different strength characteristics, such as compressive strength, tensile strength, beam strength, etc., can vary according to tube construction. The standard industry test to evaluate the strength of paper tubes is the flat crush test. This test involves compressing a tube along its sides by placing the winding tube between two flat plates. One plate is stationary while the other moves at a constant displacement rate transversely to the axis of the winding tube. The flat crush strength is the maximum load obtained during the test. The flat crush test has been relied on in the past as a general indicator of tube strength. The flat crush test may also be used to measure a stiffness property. At a given load level, the displacement between the flat plates is measured. The so-called “compression stiffness” is computed as force divided by displacement. Although this also measures tube stiffness, it is a different property than ID comedown. Compression stiffness measures response to a non-uniform two point load while ID comedown results from a uniform radial pressure. Significantly, compression stiffness testing creates bending in the core wall, while ID comedown does not.

Although paperboard tubes are typically manufactured primarily from single paper grades, multi-grade configurations are also used for various reasons. For example, in some cases, a special surface finish is needed on the tube outside diameter (OD) or on the tube ID, and a paper ply having such a finish is therefore used on the OD or ID. Different grades of paper are also used in order to satisfy other special property requirements for the tube ID or OD, for example, as might be required for interaction with a chuck or other structure. In recent years, multiple grades of paperboard have been used with the intent and effect of increasing the flat crush strength of tubes and/or to minimize ID reduction (increase ID comedown) during winding processes involving large radial compression loading.

While much focus has been devoted to innovations that improve tube strength and reduce ID comedown, tubes are subjected to other conditions that can render the winding tubes unfit for winding processes. Although these conditions may not be caused by a customer's winding processes, they can render the winding tube unable to function to wind materials. In fact, these types of failures are not even caused by loads from the winding process, which was the focus of past innovations which focused on tube strength or ID comedown. For example, large diameter tubes can be susceptible to ovality and out-of-roundness deformations at various stages of their life cycles. Such deformations can occur to the winding tubes during horizontal storage, packaging, transportation and handling, before, during or after use at the customer's facility. During these times, the winding tubes are subjected to prolonged gravitational loading that tends to deform the winding tube to a more oval shape over time. Gravitational loads can result from both internal mass distribution and the weight of other contacting bodies. These loads are very different from the external loadings discussed previously from wound textiles or film. In fact, the product innovations detailed above have never considered gravitational loading. Unfortunately, when gravitational loading is significant, the winding tubes can permanently deform to an oval cross-sectional shape even though the tube strength prevents complete collapse of the winding tubes. Though not experiencing catastrophic failure, the misshapen tubes have functionally failed if they cannot be installed on the customer's winding machine.

Existing solutions to avoid excessive ovality include vertical tube storage and decreased horizontal stack heights to reduce gravitational loading from dead weight where possible. However, these solutions can increase labor cost and storage space requirements. Where these solutions are not feasible, an alternative solution involves increasing the wall thickness of winding tubes and/or increasing the quantity of stiffer paper grades in the winding tubes. This alternative is often unacceptable as it increases the material cost of the winding tubes.

### SUMMARY OF THE DISCLOSURE

In one aspect of the present disclosure, a paperboard winding tube of enhanced compression stiffness and resistance to deformations leading to ovality under gravity type loading is disclosed. The paperboard winding tube may include a cylindrical body wall formed from a plurality of structural paperboard layers and being defined in radial cross section by at least one central structural paperboard layer disposed between at least one radially inward structural paperboard layer and at least one radially outward structural paperboard layer. The at least one radially inward paperboard layer and the at least one radially outward structural paperboard layer are formed of a paperboard ply of a first stiffness, and the at least one central structural paperboard layer is formed of a paperboard ply of a second stiffness that is less than the first stiffness. The arrangement of the plurality of structural paperboard layers thereby increases the compression stiffness of the paperboard winding tube to resist deformations leading to ovality of the cylindrical body wall under gravity type loading of the paperboard winding tube.

In another aspect of the present disclosure, a method for forming a spirally wound paperboard winding core tube of enhanced compression stiffness and resistance to flattening is disclosed. The method may include applying adhesive to a first group of paperboard plies comprising one or more continuous paperboard plies having a first stiffness, and spirally winding the first group of paperboard plies around a stationary mandrel in overlapping relation. The method may further include applying adhesive to a second group of paperboard plies comprising one or more continuous paperboard plies having a second stiffness that is less than the first stiffness, and spirally winding the second group of paperboard plies around the stationary mandrel in overlapping relation on top of the first group of paperboard plies. The method may also include applying adhesive to a third group of paperboard plies comprising one or more continuous paperboard plies having the first stiffness, and spirally winding the third group of paperboard plies around the stationary mandrel in overlapping relation on top of the second group of paperboard plies to thereby form a tube structure.

In a further aspect of the present disclosure, a paperboard winding tube having a cylindrical body wall with enhanced compression stiffness and resistance to deformation leading to ovality under gravity loading is disclosed. The paperboard winding tube may include at least one radially inward structural paperboard layer formed of a paperboard ply of a first stiffness, at least one central structural paperboard layer formed of a paperboard ply of a second stiffness that is less than the first stiffness, and at least one radially outward structural paperboard layer formed of a paperboard ply of the first stiffness. The at least one central structural paperboard layer may be positioned between the at least one radially inward structural paperboard layer and the at least one radial outward structural paperboard layer.

Additional aspects are defined by the claims of this patent.

### BRIEF DESCRIPTION OF THE DRAWINGS

FIG. 1 is a perspective view of a multi-grade spirally wound paperboard winding tube in accordance with the present disclosure;

FIG. 2 is an enlarged partial cross-sectional view taken along line 2-2 of FIG. 1 and illustrating an arrangement of paperboard layers of the paperboard winding tube of FIG. 1; and

FIG. 3 is a schematic illustration of a spiral winding process in accordance with the present disclosure for manufacturing the paperboard winding tube of FIG. 1.

### DETAILED DESCRIPTION

In the following detailed description, the embodiments are described in order to enable practice thereof. Although a textile winding tube is specifically described below, it will be apparent that improved resistance to non-round deformation is also applicable to tubes winding many other materials. It will also be apparent that various terms are used in order to describe the embodiments and not for purposes of limitation, and that tubes in accordance with the present disclosure are susceptible to numerous changes and variations as will become apparent from a consideration of the embodiments as shown in the attached drawings and described below.

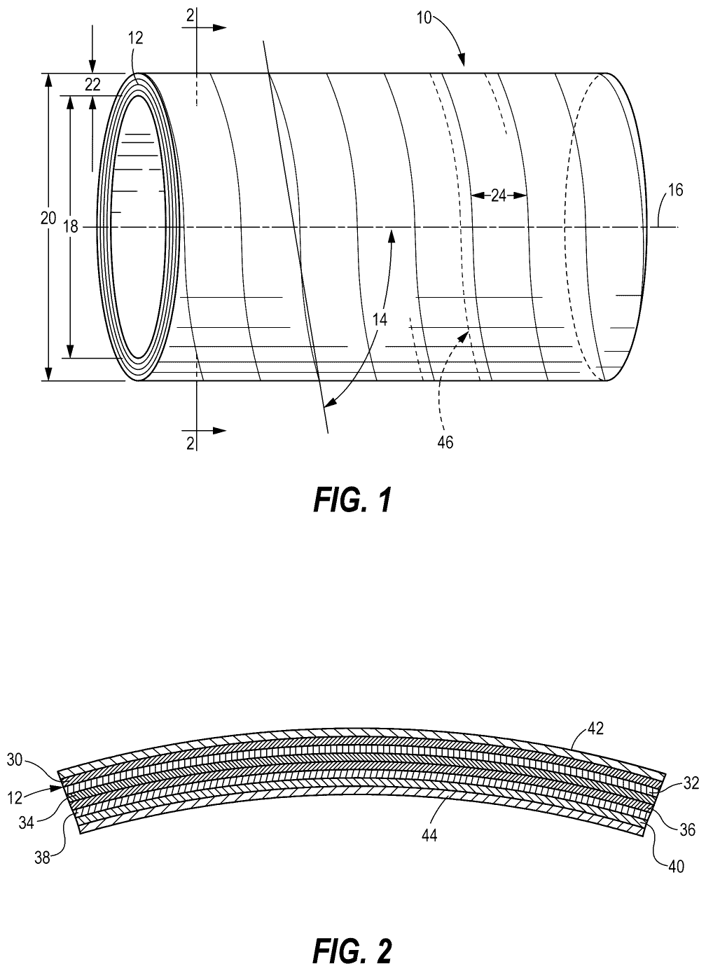

FIG. 1 illustrates a spirally wound paperboard textile winding tube 10 formed of a cylindrical body wall 12 in accordance with the present disclosure. The cylindrical body wall 12 is formed of a plurality of plies of paperboard having a spiral winding angle 14 which is expressed as the angle of wind of the paperboard plies relative to a longitudinal axis 16 of the tubular tube 10 as illustrated in FIG. 1.

As also shown in FIG. 1, the winding tube 10 has a predetermined inside diameter 18 and a predetermined outside diameter 20 which, together, define a predetermined wall thickness 22. The paperboard plies forming the winding tube 10 may have a ply width 24 which may be normally about the same for all layers of the body wall 12, but which can vary slightly in the case of a relatively thick body wall 12. The ply width 24 of the ply forming the inside surface of the winding tube 10, taken together with the inside diameter 18 of the winding tube 10, determines the spiral winding angle 14 of the winding tube 10 due to geometrical considerations.

FIG. 2 illustrates one exemplary body wall construction for body wall 12 of the spirally wound tube 10 illustrated in FIG. 1. In the body wall construction illustrated in FIG. 2, six structural paperboard layers 30, 32, 34, 36, 38, 40 may form the body wall 12. In addition, the body wall 12 illustrated in FIG. 2 includes a non-structural exterior layer 42 and a non-structural interior layer 44 that may provide various surface characteristics to the winding tube 10 discussed below.

The structural layers illustrated in FIG. 2, i.e., paperboard layers 30, 32, 34, 36, 38, 40, may be positioned to maximize stiffness of the winding tube 10 to resist permanent ovality. The paperboard plies 34, 36 are positioned in a central portion of the body wall 12. These centrally positioned paperboard plies 34, 36 are formed from lower stiffness paperboard strips. The lower stiffness results from the strips having a lower flexural or bending stiffness for resisting bending from the circular cross-sectional shape shown in FIG. 2 due to hoop stresses. The central lower stiffness paperboard layers 34, 36 are positioned between two radially outwardly positioned structural layers 30, 32, and two radially inwardly positioned paperboard layers 38, 40. The radially inwardly located layers 38, 40 and the radially outwardly located layers 30, 32 may be formed from paperboard having a stiffness higher than that of the low stiffness paperboard used to form the central paperboard layers 34, 36. The higher stiffness plies 30, 32, 38, 40 can have the same or different stiffnesses, but each have higher stiffnesses than that of the central paperboard layers 34, 36.

Although the textile winding tube 10 of FIG. 1 is shown as having six structural layers, it will be apparent to those skilled in the art that the winding tubes 10 in accordance with the present disclosure can have a wide ranging number of layers from, for example, five layers up to about fifteen to twenty five layers and higher. In some embodiments, the winding tubes 10 may include at least eight structural layers. In addition, the winding tubes 10 may include at least two or at least four lower stiffness layers, and at least two radially exterior layers and at least two radially interior paperboard layers of a higher stiffness paperboard.

Paperboard strips or plies of a widely varying range of stiffnesses and thicknesses are used to form paperboard tubes 10 as is well known in the art. Tubes 10 in accordance with the present disclosure can employ paperboard plies having thicknesses and stiffnesses throughout the ranges of thickness and stiffnesses conventionally used in the art. Typically, such stiffnesses range from about 300 KPSI to about 1,400 KPSI (about 2.1 GPa to about 9.7 GPa), and more typically from about 400 KPSI to about 1,200 KPSI (about 2.8 GPa to about 8.3 GPa). Paperboard stiffness can be derived through various testing standards, such as the Technical Association of the Pulp and Paper Industry (TAPPI) standards for determining bending resistance or stiffness of paper and paperboard that may be implemented in a device such as a Taber® Stiffness Tester from Taber Industries, with the relative stiffnesses of tested materials being expressed in corresponding units. Paperboard strength and stiffness are typically varied by varying pulp treatments, type and quality of fiber (e.g., recycled versus virgin fibers), degree of nip compression and raw materials, employing various known additives and strengthening agents, such as dry strength additives, during the paper making process, and variations in the process steps such as refining, formation technologies, wet pressing, calendering and the like. Paperboard plies conventionally used in forming winding tubes 10 and useful herein typically have a thickness within the range of between about 0.005 inches (0.13 mm) and about 0.045 inches (1.14 mm), more typically between about 0.020 inches (0.51 mm) and about 0.035 inches (0.89 mm).

The paperboard layers of higher and lower stiffnesses have a stiffness difference of at least about 10%. This difference is determined by subtracting the stiffness of the plies forming the lower stiffness paperboard layer or layers from the stiffness of the paperboard forming higher stiffness paperboard layer and expressing the difference as a percentage of the stiffness of the lower stiffness paperboard layer. Advantageously, the higher stiffness paperboard layers have a stiffness at least about 15% greater than the low stiffness layers. In embodiments, between about 10% and about 75% of the total structural layers are formed from higher stiffness paperboard. The exact ratio of high stiffness and low stiffness layers can be varied depending on tube wall thickness and stiffness requirements.

As will be apparent to those skilled in the art, non-structural layers can be formed of paperboard or non-paperboard materials including foils, films, impregnated paper layers, and the like. Such non-structural layers can be included in winding tubes 10 to provide special surface properties including a special surface finish, a gripping surface, a coloring layer or the like. For the purposes of the present disclosure, such exterior layers and interior layers which are provided for specific surface property functions, and which do not contribute substantially to wall stiffness or thickness, are considered to be non-structural layers. However, those skilled in the art will recognize that a structural layer can include a surface treatment in order to provide a desired finish, color, or the like to the exterior or interior of the tube surface. In such instances, wherein the paperboard layer is constructed and arranged for contributing both to surface characteristics such as finish, color, hardness or the like and to wall stiffness and/or thickness, such a layer may be considered to be a structural layer. For example, textile winding tubes 10 may typically include, just below the parchment layer, a paperboard layer having a surface of greater smoothness than the surface of common paperboard. This paperboard layer typically has a thickness and stiffness such that it contributes substantially to the wall thickness and stiffness of the winding tube 10, and is thus considered to be a structural layer.

Again, returning to FIG. 1, the plies forming the winding tube 10 normally are wound at a winding angle 14 of greater than about 55 degrees. In winding tubes 10 having a relatively large ID typically of between about 6.0 in. (152 mm) and 24.0 in. (610 mm), but could include up to 60.0 in. (1,524 mm), the paperboard plies forming the spirally wound paperboard winding tubes 10 preferably form a winding angle 14 of greater than 67 degrees.

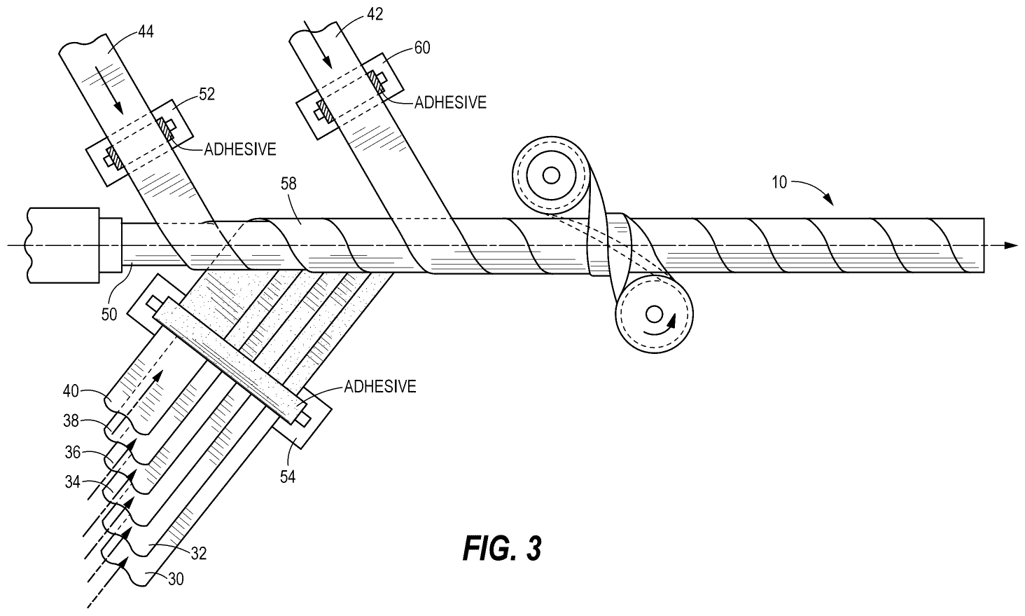

FIG. 3 schematically illustrates one exemplary process of forming multi-grade paperboard tubes 10 in accordance with the present disclosure. In FIG. 3, the innermost non-structural paperboard layer 44 may be supplied from a source (not shown) for wrapping around a stationary mandrel 50. Prior to contacting the mandrel 50, the paperboard layer 44 may be treated on its exterior face with a conventional adhesive from an adhesive supply 52. The next paperboard layer 40 is thereafter wound onto the paperboard layer 44. The paperboard layer 40, which is the innermost structural paperboard layer, is formed of a higher stiffness paperboard material as described previously. This paperboard layer 40 is typically treated on both exterior and interior faces by immersion in an adhesive bath 54, by a roller coating, or by a metering adhesive coating process as is known in the art. Thereafter, paperboard layers 38, 36, 34, 32, 30, respectively, are wound in overlapping relation onto the first two paperboard layers 44, 40 in order to build up the structure of the paperboard body wall 12. As with the paperboard layer 40, each of plies 38, 36, 34, 32, 30 are immersed in an adhesive bath 54 or are otherwise coated with adhesive prior to winding onto the mandrel 50. As discussed previously with respect to FIG. 2, it will be apparent that paperboard layers 34, 36 are lower stiffness paperboard plies while paperboard layers 30, 32, 38, 40 are higher stiffness paperboard plies. It will also be apparent that the lower stiffness paperboard layers 34, 36 will form contiguous paperboard layers positioned centrally within the body wall 12 between the radially exterior high stiffness contiguous paperboard layers 30, 32 and the radially interior high stiffness contiguous paperboard layers 38, 40.

A rotating belt 56, driven by means not shown, rotates the entire partially formed multiple layered structure 58, thereby causing the structure to move to the right on mandrel 50. Thereafter, the non-structural interior layer 42 may be applied to the outside of the partially formed tube structure 58 to thereby form the completed winding tube 10 illustrated in FIG. 1. Although not specifically shown in FIG. 3, as known to those skilled in the art, it is typical that plies provided for exterior surface smoothness, such as non-structural exterior layer 42 are applied to the partially formed tube structure 58 at a location downstream of the rotating belt 56. Prior to contacting the partially formed tube structure 58, the non-structural paperboard layer 42 may be coated on its bottom face by an adhesive supply 60 with an adhesive material. The exterior face of nonstructural exterior layer 42 contributes a predetermined surface finish or appearance to the outside of the thus formed continuous winding tube 10.

The continuous winding tube 10 is moved to the right down the mandrel 50 and is thereafter cut into parent tubes by a rotating saw or blade (not shown). Thereafter each parent tube is cut into individual tubes having a predetermined length that is chosen depending on the desired end use for the winding tube 10. The process illustrated in FIG. 3 is subject to many changes well known in the art. For example, the system can include several belts 56, feeding the plies from the same side of the mandrel 50, feeding the plies on top of or beneath the mandrel 50 as desired, or other variations.

### INDUSTRIAL APPLICABILITY

The effect of arranging paperboard layers based on stiffness in accordance with the present disclosure to achieve stiffness in a tube 10 to prevent ovality may be illustrated by the following example. A previously-known tube has an arrangement of paperboard layers for high flat crush strength. In this tube 10, the body wall 12 includes six radially inward paperboard layers with a relatively low stiffness of approximately 640 KPSI, seven radially outward paperboard layers with a relatively low stiffness of approximately 640 KPSI, and four central paperboard layers with a relatively high stiffness of approximately 827 KPSI. This tube 10 may be considered to be a 6LS-4HS-7LS construction paperboard tube 10, where “LS” represents low stiffness layers and “HS” represents high stiffness layers.

An exemplary paperboard tube 10 in accordance with the present disclosure may be formed from the same number of low stiffness layers and high stiffness layers as the previously-known tube 10, but with the high stiffness layers forming the radially inward and outward paperboard layers surrounding central low stiffness paperboard layers. Consequently, the exemplary tube 10 may have a body wall 12 with two radially inward high stiffness paperboard layers, two radially outward high stiffness paperboard layers, and thirteen central low stiffness paperboard layers. This makes the exemplary paperboard tube 10 a 2HS-13LS-2HS construction paperboard tube 10. Both the previously-known and the exemplary paperboard tubes 10 may further include a non-structural exterior layer of the type described above.

A comparison of the flat crash strength and the compression stiffness of the winding tubes 10 is set forth in Table 1 as follows:

TABLE 1

| Construction | Flat Crush Strength | Compression Stiffness |
|---|---|---|
| 6LS-4HS-7LS | 78.2 lb/in | 143.57 lb/in/in length |
| 2HS-13LS-2HS | 76.7 lb/in | 159.71 lb/in/in length |
| Difference: | −1.9% | +11.2% |

As can be seen in the data in Table 1, rearrangement of the paperboard layers from the 6LS-4HS-7LS construction to the 2HS-13LS-2HS construction results in a slight reduction in flat crush strength of approximately 1.9%. At the same time, the compression stiffness increases by approximately 11.2% with the high stiffness paperboard layers positioned radially inward and outward. This improvement is found even though the cores have the same plies and essentially the same cost. This data shows that the paperboard tube 10 in accordance with the present disclosure with the high stiffness paperboard layers arranged radially inward and outward offers comparable flat crush strength as the previously-known paperboard tube 10 while offering a significant increase in compression stiffness and resistance to ovality during conditions that tend to flatten tubes 10. The compression stiffness increase should allow the winding tubes 10 to be horizontally stored, packaged, transported and handled efficiently with reduced risk of being flattened and rejected for use in winding machines. Moreover, because the same or similar combinations of high stiffness and low stiffness paperboard layers can achieve increases in compression stiffness, the paperboard tubes 10 in accordance with the present disclosure should maintain similar material and manufacturing costs as previously-know tubes 10 that may be more susceptible to flattening.

The paperboard tubes 10 in accordance with the present disclosure are susceptible to numerous changes and variations. For example, these tubes 10 have been described in connection with the use of paperboard plies having two different stiffnesses. However, the winding tubes 10 can also be used with paperboard plies of three or more different stiffnesses. In such instances, intermediate stiffness paperboard plies may be preferably positioned adjacent the central, low stiffness paperboard plies on both sides thereof. Thus, the intermediate stiffness paperboard plies may be preferably divided into substantially equal portions. One portion may be used to provide contiguous intermediate stiffness layers between the central low stiffness paperboard plies and the radial outward high stiffness plies. The other intermediate stiffness plies may preferably be positioned contiguously between the central low stiffness paperboard plies and the radially inwardly high stiffness plies.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A paperboard winding tube of enhanced compression stiffness and resistance to deformations leading to ovality under gravity type loading, comprising:
a cylindrical body wall formed from a plurality of structural paperboard layers and being defined in radial cross section by at least one central structural paperboard layer disposed between at least one radially inward structural paperboard layer and at least one radially outward structural paperboard layer,
wherein the at least one radially inward structural paperboard layer and the at least one radially outward structural paperboard layer are formed of a paperboard ply of a first stiffness, and
where the at least one central structural paperboard layer is formed of a paperboard ply of a second stiffness that is less than the first stiffness, the arrangement of the plurality of structural paperboard layers thereby increasing the compression stiffness of the paperboard winding tube to resist deformations leading to ovality of the cylindrical body wall under gravity type loading of the paperboard winding tube.

2. The paperboard winding tube of claim 1, comprising at least five structural paperboard layers including at least two contiguous centrally structural paperboard layers formed from the paperboard ply with the second stiffness.

3. The paperboard winding tube of claim 2, wherein the cylindrical body wall is a spirally wound paperboard body wall.

4. The paperboard winding tube of claim 1, wherein the at least one central structural paperboard layer comprises two central structural paperboard layers formed of the paperboard ply of the second stiffness, wherein the at least one radially inward structural paperboard layer comprises two radial inward structural paper board layers formed of the paperboard ply of the first stiffness, and wherein the at least one radially outward structural paperboard layer comprises two radial outward structural paper board layers formed of the paperboard ply of the first stiffness.

5. The paperboard winding tube of claim 1, wherein the at least one central structural paperboard layer comprises thirteen central structural paperboard layers formed of the paperboard ply of the second stiffness, wherein the at least one radially inward structural paperboard layer comprises two radial inward structural paper board layers formed of the paperboard ply of the first stiffness, and wherein the at least one radially outward structural paperboard layer comprises two radial outward structural paper board layers formed of the paperboard ply of the first stiffness.

6. The paperboard winding tube of claim 1, wherein the first stiffness is 827 KPSI and at second stiffness is 640 KPSI.

7. The paperboard winding tube of claim 1, comprising at least fifteen structural paperboard layers.

8. The paperboard winding tube of claim 1, wherein the first stiffness is at least 10% greater than the second stiffness.

9. The paperboard winding tube of claim 1, comprising at least one non-structural layer disposed on an exterior surface of the cylindrical body wall.

10. A method for forming a spirally wound paperboard winding tube of enhanced compression stiffness and resistance to flattening, the method comprising:
applying adhesive to a first group of paperboard plies comprising one or more continuous paperboard plies having a first stiffness;
spirally winding the first group of paperboard plies around a stationary mandrel in overlapping relation;
applying adhesive to a second group of paperboard plies comprising one or more continuous paperboard plies having a second stiffness that is less than the first stiffness;
spirally winding the second group of paperboard plies around the stationary mandrel in overlapping relation on top of the first group of paperboard plies;
applying adhesive to a third group of paperboard plies comprising one or more continuous paperboard plies having the first stiffness; and
spirally winding the third group of paperboard plies around the stationary mandrel in overlapping relation on top of the second group of paperboard plies to thereby form a tube structure.

11. The method of claim 10, wherein the first group of paperboard plies comprises at least two continuous paperboard plies having the first stiffness, the second group of paperboard plies comprises at least two continuous paperboard plies having the second stiffness, and the third group of paperboard plies comprises at least two continuous paperboard plies having the first stiffness.

12. The method of claim 11, wherein the second group of paperboard plies comprises at least ten continuous paperboard plies having the second stiffness.

13. The method of claim 12, wherein the second group of paperboard plies comprises thirteen continuous paperboard plies having the second stiffness.

14. The method of claim 10, comprising:
applying adhesive to an exterior surface of a non-structural interior ply;
before spirally winding the first group of paperboard plies around the stationary mandrel, spirally winding the non-structural interior ply around the stationary mandrel.

15. A paperboard winding tube having a cylindrical body wall with enhanced compression stiffness and resistance to deformation leading to ovality under gravity loading, the paperboard winding tube comprising:
at least one radially inward structural paperboard layer formed of a paperboard ply of a first stiffness;
at least one central structural paperboard layer formed of a paperboard ply of a second stiffness that is less than the first stiffness; and
at least one radially outward structural paperboard layer formed of a paperboard ply of the first stiffness,
wherein the at least one central structural paperboard layer is positioned between the at least one radially inward structural paperboard layer and the at least one radial outward structural paperboard layer.

16. The paperboard winding tube of claim 15, wherein the at least one central structural paperboard layer comprises two central structural paperboard layers formed of the paperboard ply of the second stiffness, wherein the at least one radially inward structural paperboard layer comprises two radial inward structural paper board layers formed of the paperboard ply of the first stiffness, and wherein the at least one radially outward structural paperboard layer comprises two radial outward structural paper board layers formed of the paperboard ply of the first stiffness.

17. The paperboard winding tube of claim 15, wherein the first stiffness is at least 10% greater than the second stiffness.
